(19) United States
(12) Patent Application Publication
(10) Pub. No.: US 2006/0047486 A1
(43) Pub. Date: Mar. 2, 2006

(54) Method to assist with the design and fitting out of a space

(76) Inventor: Ronan Lebraut, Le Vesinet (FR)

Correspondence Address: BROWDY AND NEIMARK, P.L.L.C.;624 NINTH STREET, NW, SUITE 300, WASHINGTON, DC, 20001-5303, US

(21) Appl. No.: 10/924,191

(22) Filed: Aug. 24, 2004

(51) Int. Cl. G06F 17/50

(52) U.S. Cl. 703/1

(57) ABSTRACT

The method according to the invention concerns a process of assistance with the fitting out of a space, where this method implements a management and assistance unit (U) in connection with a variety of suppliers, and to which a user/customer (Blocks C11-Cln), equipped with a local unit (Blocks UL1-ULn), is able to connect, where the said method comprises the following stages: 2D or 3D modelling by the unit (U) of the fitting-out elements (Blocks BD1-BDn) of the said suppliers (Blocks F1-Fn) in accordance with a predetermined standard, incorporation by the said unit (U) of the modelled elements into a database (Block 1) which can be accessed by the users, making available to the user/customer by the unit (U) of a 2D or 3D modelling application, modelling by the user/customer on his local unit (Blocks UL1-ULn) of a space using the said application in accordance with the standards of the application, selection by this user/customer on his local unit of modelled elements in the said database, positioning by the user/customer on his local unit of the elements selected in the said space, and viewing in 2D or 3D of the space in which the elements are positioned. This applies in particular to the fields of architecture and interior decoration.

This present invention concerns a method of assistance with the design and the fitting out of a space. It applies most particularly, but not exclusively, to the fields of architecture and interior decoration.

In general, the fitting out of a space, such as a living space or an exhibition stand for example, is subject to several conditions, not only of an aesthetic nature but also of a technical nature. In addition, it is dependent upon the fitting-out elements available in the retail trade and which are offered by a variety of suppliers. In all of these cases of course, the elements concerned must fit easily into the appropriate position. Now it is rather tedious to be obliged to take all of the necessary measurements here, given that if the dimensions of the furniture article are not suitable, then one of the alternatives offered is to envisage another location, and this means taking more measurements.

One solution would be to propose a simulation of the incorporation of elements into the space for which they are intended.

However, there are many difficulties that have to be surmounted:
the number of suppliers concerned is considerable, and the articles in their catalogues are presented in accordance with different standards, so that it is impossible to incorporate them into any given space specified by the user,
the space itself has to be modelled in accordance with a standard which will favour incorporation of the articles.

The particular subject of the invention is therefore a method which allows an individual to achieve such an incorporation process in a space that he has specified himself.

To this end, it proposes to arrive at this result by means of a method which makes use of a management and assistance unit in connection with a variety of suppliers, and which a user/customer, equipped with a local unit, is able to contact over a communication network such as the Internet, for example.

According to the invention, this method comprises the following stages:
2D or 3D modelling, by the management and assistance unit, of the fitting-out elements of the different suppliers in accordance with a predetermined standard,
incorporation, by the said management unit, of the modelled elements into a database that can be accessed by the users/customers,
making available, by the management unit to the user/customer, of a 2D or 3D modelling application by means of the communication network, for example,
modelling of a space by the user/customer, on his local unit, using the said application in accordance with the standards of the application,
selection of modelled elements in the said database, by this user/customer on his local unit,
positioning of the elements selected from the said space, by the user/customer on his local unit,
viewing in 2D or 3D of the space in which the elements are positioned.

Thus the database will also be able to comprise photos of the modelled elements, as well as a variety of information such as dimensions, prices, and references, so as to achieve a presentation that is both practical and aesthetically pleasing.

The database of modelled elements can be interrogated in accordance with numerous criteria, such as dimensions, materials, styles, and function, using a search engine placed at the disposal of the user/customer by the management unit.

Modelling of the space can take account of many criteria such as dimensions or works reservations corresponding to the water supply points, radiators, and any constraints (distance, proximity, connections, etc.).

The predetermined standard for modelling of the elements and of the spaces enables them to be represented on the same scale, in order to achieve an incorporation which is realistic or even standardised.

Viewing can be in 2D in the form of a 2D layout (schematic plan view) or in 3D with the ability to “move” in the space.

Positioning of the element or elements selected in the modelled space can be performed by means of a graphical interface in which the user/customer only has to drag the element to the selected position in the space so that the latter is incorporated in accordance with the dimensional scales.

In accordance with a variant, the positioning of the chosen elements can take place automatically in the modelled space after the user/customer has indicated the function for example of the space such a bathroom. In this event, several configurations can be proposed, all complying with the constraints given for the modelling of the said space (version with a bath or a shower, etc.).

Where appropriate, implementation of this method can involve the use of a network such as an intranet or the Internet, or of an interactive terminal located at in a retail outlet.

It can also envisage that a supplier could provide its customer with the means to implement the method and to access the content of its catalogue by means of a CDROM for example. It could provide the customer with privileged access to a server in order to have the ability to use the method. In this event, it could supply only the content of its catalogue, while choosing whether or not to build in the ability to load or download others catalogue contents.

In addition, in the case where a network is used, it can comprise counting of the accesses to the database in order to prepare statistics or to invoice suppliers, on the basis of the rate of consultation of their products for example.

An on-line order module can also be comprised.

Methods of execution will be described below, by way of non-limited examples, with reference to the appended figures, in which:

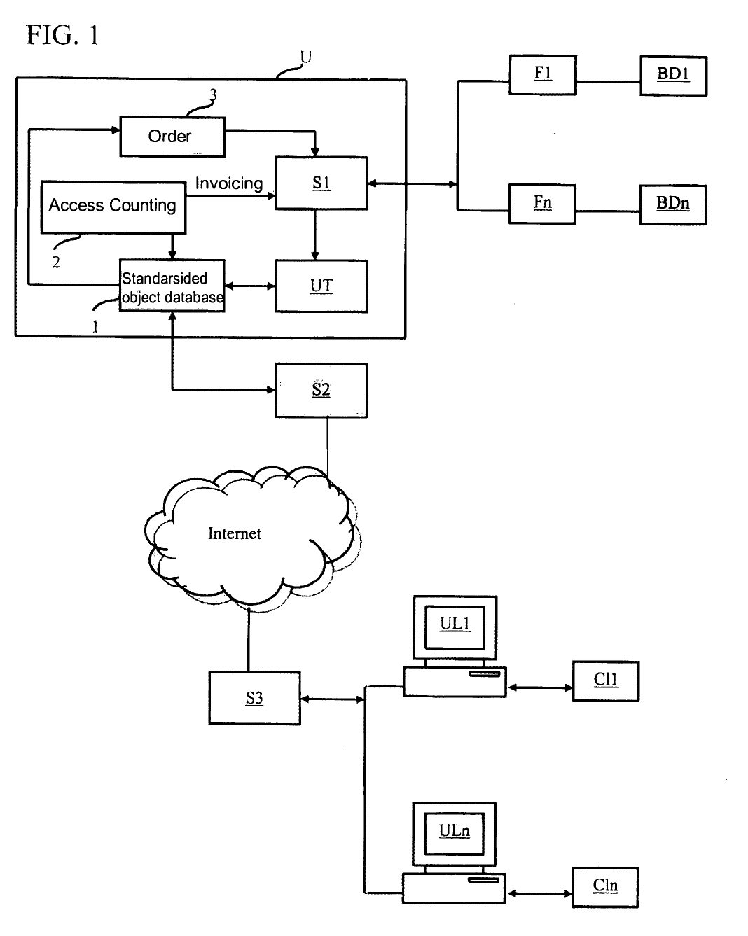

FIG. 1 is a representation of a simplified flow-chart of a method according to the invention;

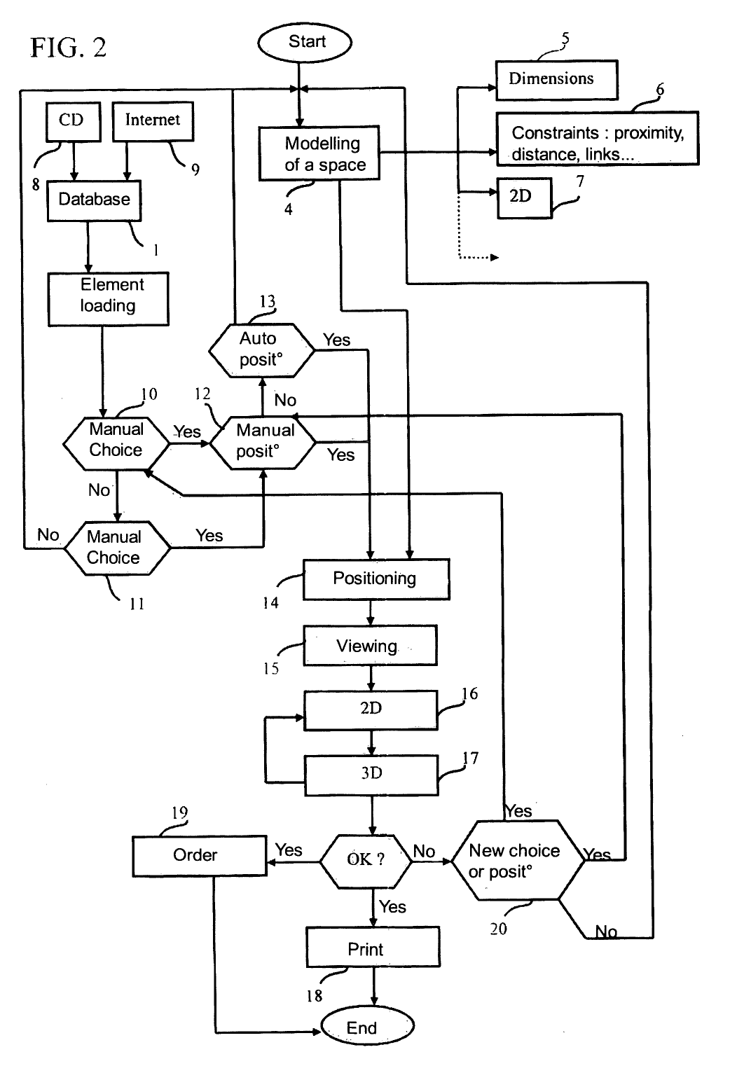

FIG. 2 is a representation of a flow-chart of the implementation of the method according to the invention as illustrated in FIG. 1;

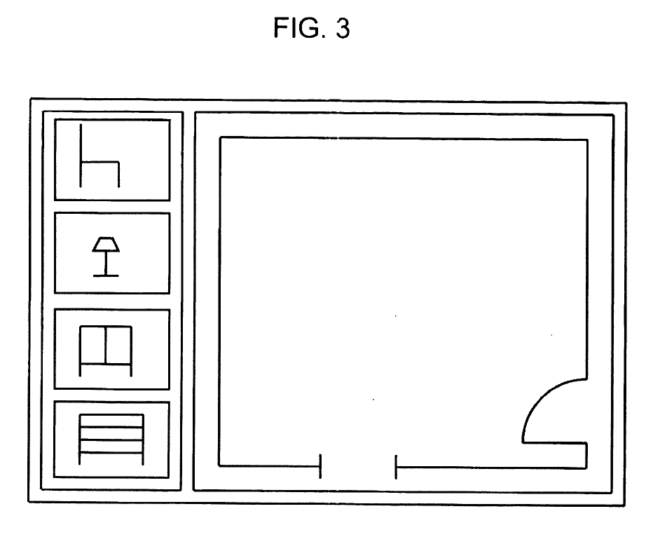

FIG. 3 is a representation of a graphical interface for positioning of the chosen modelled elements in the space;

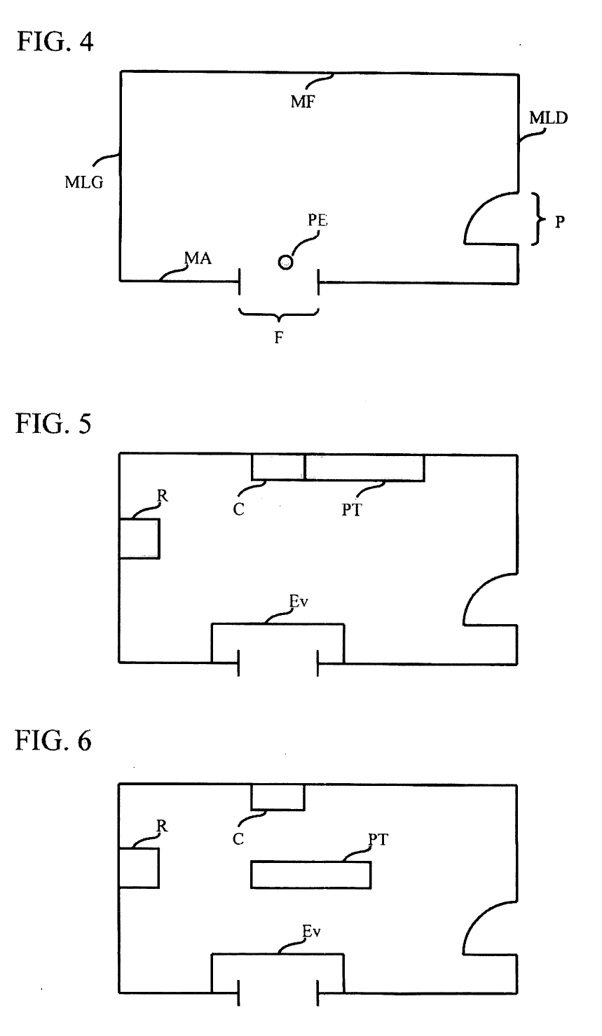

FIG. 4 is a representation of the modelling of a space as effected by a customer;

FIG. 5 is a representation of a configuration of elements incorporated into the modelled space of FIG. 2;

FIG. 6 is a representation of a second configuration of elements incorporated into the modelled space of FIG. 2.

In the example of FIG. 1, the simplified flow-chart of a method in accordance with the invention comprises the following stages grouped into a block filling the role of a management and assistance unit in particular:
centralisation of the data of one or more supplier databases (blocks BD1-BDn), in a supplier server (block S1),
2D or 3D modelling, in accordance with a predetermined standard, of the elements of the suppliers, by means of a processing unit (block UT),
incorporation of the modelled elements into a database (block 1) that can be accessed by the users/customers.

The data are then transmitted by means of a server (Block S2) connected to the Internet, and they end up on a customer terminal which can be a server (block S3) for example, which transmits to several local units (blocks UL1-ULn) used by the customers (blocks C11-Cln) or directly to a local unit of a customer.

It should be noted that counting of the accesses (Block 2) can be envisaged so as to allow invoicing of the suppliers in accordance with the rate of consultation of their elements.

An on-line order module (Block 3) connected firstly to the database and secondly to the suppliers, via server S2 for example, can be installed.

The stages of the method implemented are then as follows (FIG. 2):

Firstly,
the modelling of a space in accordance with a standard (Block 4) by a customer, where this modelling necessitates the acquisition of information of various types such as dimensions (Block 5), constraints (Block 6) (proximity, distance, linking, etc.), the use of two dimensions (Block 7), and so on, and

Secondly,
the use of the database of modelled elements (Block 1), accessible for example via the Internet (Block 8) or by a CD ROM (Block 9),
a manual (Block 10) or automatic (Block 11) choice of modelled elements,
a manual (Block 12) or automatic (Block 13) positioning of the modelled elements,
the positioning (Block 14) of the elements selected is viewed (Block 15), and this viewing can take place in 2D (Block 16) or 3D (Block 17),
if the customer is satisfied, he can print the result (Block 18) or can place an order directly (Block 19) with the supplier or suppliers concerned,
if the customer is not satisfied with the configuration, he can perform a fresh choice of elements or of position (Block 20).

If the customer uses automatic choice of elements, this choice will be based on the indication of the function of the modelled space and, where appropriate on certain additional aspects such as colours, materials, etc.

If the customer uses automatic positioning, the said positioning will be effected in the light of the information used (Blocks 5 to 6) for the modelling of the space.

Each supplier F models the content of its catalogue or has it modelled. Each fitting-out element is thus “scanned” in 2D or 3D, its dimensions are recorded, one or more photos are taken, and all these data are programmed as parameters in accordance with the predetermined standard and entered into the database together with their names, the name of the collection of which they form a part, their functions, and their supplier references. Each type of data gives rise to a category.

In particular, the modelling standard establishes a scale in accordance with which all of the modelling is effected.

The supply of information for modelling of the space can be effected by completing different fields with information such as dimensions, the position of openings, obstacles (radiators, reinforcing, etc.), functional reservations (water intake, etc.), the function of the room (kitchen, bathroom, etc.), the colour of the walls and the floors, or by using a simplified drawing application, possibly with a graphical palette.

Positioning is also accomplished by means of a graphical interface IG (FIG. 3). Part of the screen E1 shows the selected elements, and another part E2 shows the modelled space. It is then necessary for the customer to move the chosen element or elements to an area of the modelled space in order for the latter to be incorporated if the various constraints match those of the area in question.

The customer thus has a display of his modelled space in 2D and/or 3D, in accordance with the predetermined standard.

The 2D representation can be a overhead view of the space. This is particularly convenient in order to check that the dimensions of the elements match those of the space.

The representation 3D, in particular when it shows the effects of material and of colour, allows one to achieve a very realistic simulation of the result of incorporating elements into a given space.

More specifically, in the case of a kitchen, the customer has modelled a rectangular space that comprises a back wall MF, a left side wall MLG, a door P located in the middle of the right side wall MLD, a window F in the middle of the front wall MA with a water point PE underneath (FIG. 4). There can be elements from a collection X, from a collection Y, and from a collection Z, where these elements consist, for example, of a sink Ev, a cooker C, a refrigerator R, and a work surface PT.

For each collection, several configurations with different arrangements of furniture articles will be offered to the customer.

In FIG. 5 for example, a configuration can locate the work surface PT and the cooker C on the back wall M, the sink Ev under the window F, and the refrigerator R on the left side wall MLG.

In another configuration, illustrated in FIG. 6, the work surface PT is in the centre of the room.

1. Method to assist with the fitting out of a space, where this method implements a management and assistance unit in connection with a variety of suppliers, and to which a user/customer equipped with a local unit) can make contact, comprising the following stages:
2D or 3D modelling, by the management and assistance unit, of the fitting-out elements of the various suppliers in accordance with a predetermined standard,
incorporation by the said management unit of the modelled elements into a database that can be accessed by the users,
making available to the user/customer, by the management unit, of a 2D or 3D modelling application
modelling by the user/customer, on his local unit, of a space, using the said application, in accordance with the standards of the application,
selection by this user/customer, on his local unit, of modelled elements in the said database,
positioning by the user/customer, on his local unit, of the elements selected in the said space,
viewing in 2D or 3D of the space in which the elements are positioned.

2. Method according to claim 1, wherein the making available to the user/customer, by the management unit, of a 2D or 3D modelling application, is effected by means of a communication network.

3. Method according to claim 1, wherein the said database comprises photos of the modelled elements, as well as different information such as dimensions, prices, references, etc.

4. Method according to claim 1, wherein the database of modelled elements is interrogated in accordance with numerous criteria such as dimensions, materials, style, and function, using a search engine placed at the disposal of the user/customer by the management unit.

5. Method according to claim 1, wherein the modelling of the space takes account of numerous criteria such as dimensions, constraints), reservations corresponding to the water feeds, radiators, etc.

6. Method according to claim 1, wherein viewing can take place in 2D in the form of a 2D layout, or in 3D with the ability to “move” in the space.

7. Method according to claim 1, wherein the positioning of the elements selected in the modelled space is effected by means of a graphical interface, in which the user/customer drags the element to the chosen position in the space so that the latter is incorporated in accordance with the dimensional scales.

8. Method according to claim 1, wherein the said selection of the modelled elements is automatic.

9. Method according to claim 1, wherein the positioning of the selected elements occurs automatically in the modelled space after the user/customer has indicated the function of the space for example.

10. Method according to claim 1, wherein it is used on an interactive terminal located in a retail outlet.

11. Method according to claim 1, wherein the means for implementing the process, and the content of the catalogue, are stored on a CD-ROM.

12. Method according to claim 1, wherein, when used in a network, it comprises recording of the accesses to the database in order to compile statistics or to invoice the suppliers.

13. Method according to claim 1, comprising an on-line control module.
